(19) United States
(12) Patent Application Publication
(10) Pub. No.: US 2024/0350366 A1
(43) Pub. Date: Oct. 24, 2024

(54) DEVICE FOR PRODUCING A PHARMACEUTICAL, DIETARY SUPPLEMENT OR COSMETIC

(71) Applicant: Guido Knobel, Salenstein (CH)

(72) Inventor: Guido Knobel, Salenstein (CH)

(21) Appl. No.: 18/686,106

(22) PCT Filed: Jun. 29, 2022
(86) PCT No.: PCT/EP2022/067953

§ 371 Date: Feb. 23, 2024

(30) Foreign Application Priority Data
Aug. 25, 2021 (DE) 10 2021 122 015.7

(51) Int. Cl. A61J 3/06; A61J 1/03; B65B 5/10

(52) U.S. Cl. CPC A61J 3/06; A61J 1/035; B65B 5/103

(57) ABSTRACT

In a device for producing a pharmaceutical, dietary supplement or cosmetic from at least one active ingredient, wherein the production takes place in a filling station (1) in at least one cavity (7) of a mold (6), a feed line (30) for a substance for a shell or for a thickening agent, and at least one further feed line (27.1 to 27.3, 29) for the active ingredient should be assigned to the cavity (7), or the last-mentioned feed lines (27.1-27.3) should be assigned directly to a receiving container.

### BACKGROUND OF THE INVENTION

The invention relates to a device for producing a pharmaceutical, dietary supplement or cosmetic from at least one active ingredient, wherein the production takes place in a filling station in at least one cavity of a mold, and to a method therefor.

Pharmaceutical and/or cosmetic products, such as dietary supplements, tablets or the like, are nowadays generally produced industrially in large numbers, in corresponding facilities. These are for example tablets which are always produced, filled and packaged according to the same formulation. However, nowadays there is a growing wish for such products to be produced according to specific formulations, for example when more medicinal herbs or the like, and formulations according to old knowledge are intended to be used again. It will also be desirable in the future to adjust the composition of formulations depending on the patient and/or their illness. This is of course not possible on an industrial scale, but rather can be achieved only using machines which make it possible to produce a smaller number of tablets.

For this purpose, for example DE 10 2007 051 757 A1 describes a method for the automatic production of pharmaceutical preparations dosed individually for the patient, but a corresponding method for this is not offered. Similar also applies for DE 10 2014 105 989 A1.

Only WO 2020/099387 A describes a tablet press for the automated production of a specifiable number of individualized tablets, which press is very complicated in terms of design and handling.

### SUMMARY OF THE INVENTION

The problem addressed by the present invention is that of providing a device and a method of the type mentioned above, by means of which patient-specific pharmaceuticals, dietary supplements or cosmetics can be produced on a small scale, by persons authorized to do so, in a simple manner.

The problem is solved in that a feed line for a substance for a shell or for a thickening agent, and at least one further feed line for the active ingredient, are assigned to the cavity, or the last-mentioned feed lines are assigned directly to a receiving container.

Above all tablets, but also liquids or other administration forms are possible as the administration form according to the present invention. If reference is made in the following merely to tablets, the corresponding liquids or other administration forms are of course also covered by the inventive concept. If reference is made in the following to (a) pharmaceutical(s) or a pharmaceutical substance, then this is also intended to mean, however, dietary supplements or cosmetics and the corresponding active ingredients necessary therefor. They are therefore always intended to be included by the term.

In terms of the state of aggregation, the filling medium also has a large spectrum between liquid and solid, for example a consistency such as honey or batter is possible. The system according to the invention can also serve for filling using aerated masses of any type, from the micron size up to several millimeters. In this case the aeration can consist of gasses of any type for example. Filling media mixed with solid bodies and/or gas supply are also possible. The scope of the invention also covers the situation of filling using foamed masses. These can also be mixed with solid bodies and/or gas supply.

For one thing, the scope of the invention covers the situation of the feed line(s) for the active ingredients leading directly into a container, for example a vial or a powder tin. The pharmaceutical can then be removed directly from said container by the user.

However, the scope of the invention in particular also covers the production of the pharmaceutical in tablet form. In order for the tablet to have sufficient rigidity, it may be conceivable for a thickening agent to be added to the pharmaceutical substance(s).

However, the invention relates above all to the production of tablets comprising a shell, in which the pharmaceutical substance is received. This embodiment makes it possible for the tablet to be able to be produced in a single shot—this is also referred to as the “one shot method”. A simple form of the one shot method for foodstuffs is disclosed for example in WO 94/02027. However, it is above all also known in confectionary engineering. Here, when producing filled chocolates, cavity is filled with chocolate for the outer shell using one nozzle, and the content of the filled chocolate is filled into the chocolate shell, forming it, using a further nozzle, such that ultimately a closed filled chocolate is produced.

The present device according to the invention provides a feed line for the substance for the shell, which is arranged around the feed line for the pharmaceutical substance. This means that the outputs of the two feed lines are arranged in or above the cavity, such that it is now necessary to control only the supply of the substances for the shell and the supply of the pharmaceutical substance.

Since the present invention is intended to be used above all in the production of tablets from a plurality of pharmaceutical substances, a plurality of feed lines of the pharmaceutical substances is provided. These are intended to first enter a mixing chamber, in order that a homogeneous mixture of the active ingredients can be produced before this is filled into the cavity.

It is intended in particular to produce the pharmaceutical substances in their pure form, in cartridges, and to offer these for use together with the present device. This means that the user, for example a pharmacist, should keep a stock of a plurality of cartridges comprising different pharmaceutical substances. Depending on the desired prescription for the tablets, said user can then assemble the cartridges in the device, such that the prescription is then produced in the mixing chamber.

The substance for the shell is also provided in a cartridge, wherein of course, if desired, cartridges comprising different substances for a shell are also offered.

It is important in the case of the cartridges that they or their content should be able to be checked precisely, such that no mix-up can occur. This is intended to include, within the scope of the invention, any conceivable checking or monitoring means—for example, the “RFID” method can be used. Similar of course also applies for the monitoring of the amount of the supply of pharmaceutical substances, such that it may prove to be advisable to assign a corresponding weighing means to the cartridges. However, this is just one embodiment.

The pharmaceutical substances can be present in the cartridge in powder form, or in liquid or meltable form. The same also applies for the substance for the shell. Melting will generally be possible only using heat, and therefore, according to the invention, the corresponding cartridge is also associated with a heating device. Said individual heating devices can preferably also be controlled individually. For this reason, the cartridges are also spaced apart from one another, in order that there cannot be any temperature influence from adjacent cartridges.

For the sake of simplicity, the removal of the substance from the cartridge will take place using a piston, which applies pressure to the substance in the cartridge. In this case, the piston will preferably be connected via a plunger to a drive, which can apply pressure to the plunger and thus to the piston. The way in which said drive is designed is intended to be less important. Many possibilities are conceivable here, wherein they may be electric, hydraulic, pneumatic or also manual drives. In each case, however, it may be advisable to detachably connect the plunger to the drive, in order that easy changing of the cartridges can take place.

An important point of the invention is also that the plunger is movable not only in one direction for pushing the substances out of the cartridges, but rather also in the opposite direction. As soon as the cavity is sufficiently filled with the substances, the piston or pistons should be retracted a small amount, in the cartridges, in order that dripping of substance into the cavity is prevented.

Such tablets are produced merely individually in a cavity in only a few cases; in the vast majority of cases, the production should take place in a complete blister pack, comprising a plurality of cavities. In order to protect the tablets from mechanical action and environmental influences, it may be advisable to close said blister packs, which is performed in a following sealing station, using a foil. For this purpose, the blister is exposed to nitrogen before the foil is applied. A sealing tool is integrated into said sealing station, which tool is exchangeable in order that different geometries of molds can be taken into account. Furthermore, a stamping tool should also be integrated, by means of which the foil is stamped out in the outlines of the mold.

Following said sealing station, it may be necessary to also cool the blister packs, in order that the tablets are brought back to room temperature. A cooling station of this kind can be of any design.

Lastly, the blister pack also passes through a labelling station, in which all the necessary data are applied to the blister pack.

For the sake of simplicity, the transport of the mold from the filling station to the sealing station, cooling station and labelling station takes place on a single conveyor belt, which facilitates the production.

The present invention also relates to a method for producing tablets from at least one pharmaceutical substance in a shell, wherein the production takes place in a filling station, in at least one cavity of a mold, wherein one feed for a substance for the shell and at least one further feed for the pharmaceutical substance, to the cavity, takes place at least in part simultaneously. This is carried out in the one shot method described above, such that each tablet is produced by a single shot. This of course substantially increases the speed of the tablet production, and the effectiveness of the entire device.

If a plurality of pharmaceutical substances is intended to be made into tablet form, then, according to the method according to the invention, these are mixed in a mixing chamber, and the substance for the shell is supplied to the cavity at the same time. This ensures that, firstly, the substance for the shell forms a base and optionally walls for receiving the mixture of the pharmaceutical substances. After the supply of the pharmaceutical substances to the cavity, a supply of the substance for the shell takes place until the substance for the shell encases the pharmaceutical substance. Only then is the tablet fully produced and ready for use.

### BRIEF DESCRIPTION OF THE DRAWINGS

Further advantages, features and details of the invention emerge from the following description of preferred embodiments, and with reference to the drawings, in which:

FIG. 1 is a perspective view of a device according to the invention for producing tablets;

FIG. 2 is a front view of the device according to FIG. 1, with a removed protective wall;

FIG. 3 is a side view of a part of the device according to FIG. 2;

FIG. 4 is an enlarged and opened detail of the front view of the device according to FIG. 2;

FIG. 5 is a side view of a further part of the device according to the invention according to FIG. 1.

### DETAILED DESCRIPTION

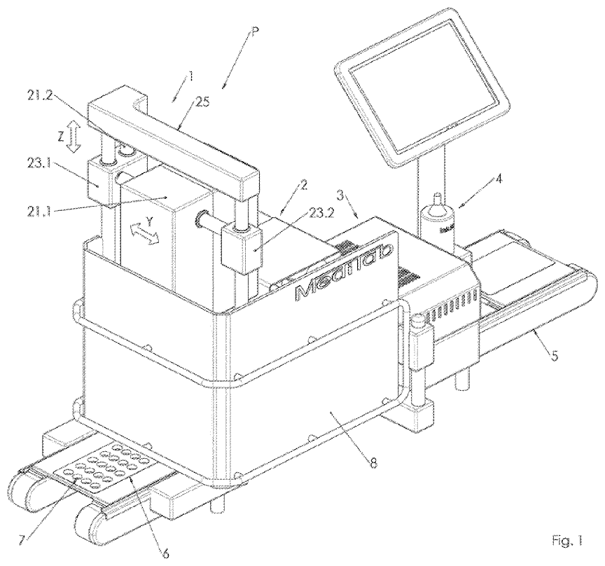

According to FIG. 1, a device P according to the invention for producing tablets in every case comprises a filling station 1. A sealing station 2 and/or a cooling station 3 and/or a labelling station 4 can be arranged downstream of said filling station. The stations 1, 2, 3 and 4 are interconnected by a transport device 5, by means of which molds 6 comprising cavities 7 can be transported through the stations.

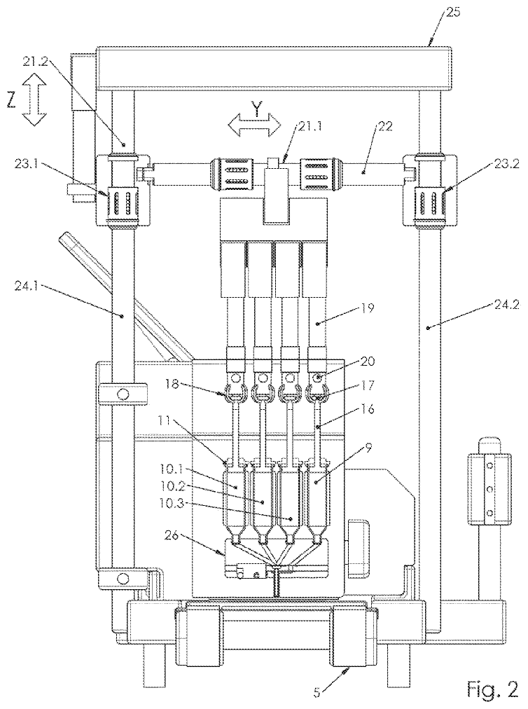

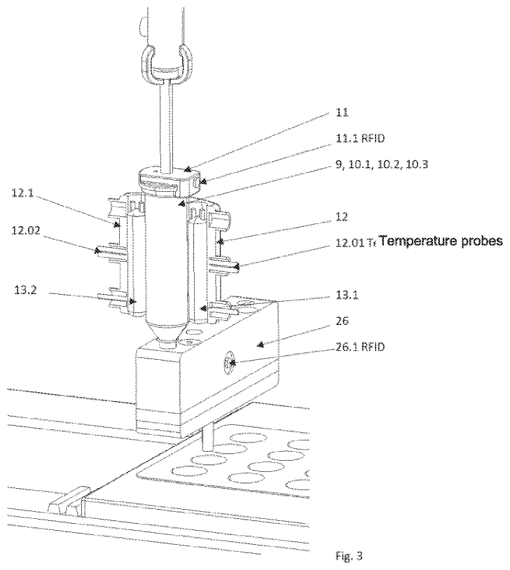

In the filling station 1, which is shown in particular in FIGS. 2 and 3, behind a protective wall 8 an arrangement of elements for filling the substances for the tablets is located. In this case, a substance for a shell is located in a cartridge 9, beside which further cartridges 10.1, 10.2 and 10.3 for pharmaceutical substances are arranged.

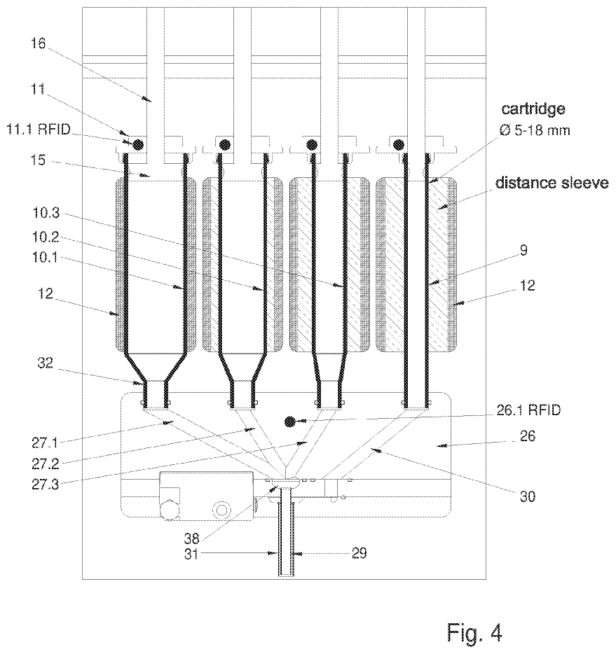

The cartridge arrangements are more clearly visible in FIG. 4, wherein the cartridge arrangements are designed substantially identically. Each cartridge 9, 10.1 to 10.3 is closed by a cover 11 and is surrounded by a cladding 12. In this case, according to FIG. 3 heat packages 13.1 and 13.2, which are supplied with electrical energy via lines 14, are located in front of and behind the cladding 12. Said heat packages 13.1 and 13.2 are monitored by means of temperature probes 12.01 and 12.02, respectively. Furthermore, a sensor 11.1 is provided on the cover 11, which sensor serves for identifying the cartridge. This is preferably an RFID sensor.

A piston 15, which is arranged on a plunger 16, presses on the substance in the cartridge 9 or 10.1 to 10.3, wherein the plunger 16 leads through the cover 11. A counter bearing 17 is provided on the end of the plunger 16, below which counter bearing clamps 18 engage. Said clamps 18 establish a releasable connection to a drive train 19, which is vertically movable. The releasable connection can also be overcome manually by a button 20.

Each drive train 19 is connected, shown only schematically here, to a drive 21.1, 21.2 which makes it possible for each drive train 19 to be able to be moved separately, or also for all drive trains to be moved together, in a horizontal manner. For example, the drive 21.1 may be a crank drive, the horizontal shaft 22 of which is movable up and down, via guide sleeves 23.1 and 23.2 along guide columns 24.1 and 24.2, on a cross-frame 25.

A distribution block 26 is provided under the cartridges 9 or 10.1 to 10.3, which block is again shown in more detail in FIG. 4 and is likewise monitored by a sensor, for example an RFID sensor 26.1. In this case, it can be seen that the cartridges 10.1 to 10.3 are connected to a mixing chamber 38 by respective feed lines 27.1 to 27.3. A pressure line 29 leads out of said mixing chamber 38 to the cavity 7, wherein mixed substances can be introduced into the cavity 7 from the pressure line 29.

Furthermore, a feed line 30 is provided in the distribution block 26, which line is connected to the cartridge 9 and which comprises a substance for the shell of the tablet. Said feed line 30 is connected to a cladding tube 31 which surrounds the pressure line 29, wherein the substance for the shell is supplied to the cavity 7 between the cladding tube 31 and the pressure line 29.

The mode of operation of the present invention is as follows:

The problem, for example for a pharmacist, consists in producing a tablet having a predetermined pharmaceutical substance, in a shell, for a customer. The corresponding pharmaceutical basic substances are located in different cartridges 10.1 to 10.3, wherein said cartridges are labelled according to their content. For example, an RFID chip (Radio Frequency Identification) is suitable for this purpose, which chip belongs to the transceiver system of the same name for automatic object identification. This is a system for automatic and contactless identification and location of objects using radio waves.

Depending on the requirements on a prescription or the like, the pharmacist removes the corresponding cartridges 10.1 to 10.3 and inserts them into the filling station 1, wherein they are surrounded by the cladding 12 and are located between the heat packages 13.1 and 13.2. A corresponding read device behind the cartridges 10.1 to 10.3 identifies which cartridges they are, comprising which pharmaceutical substances, and whether these cartridges are correct.

When the cartridges 10.1 to 10.2 are inserted, a corresponding neck 32 is also inserted in a sealing manner into the distribution block 26, such that said neck 32 comes into flow contact with the respective feed line 27.1 to 27.3.

Likewise, the cartridge 9 comprising the substance for the shell is inserted into the filling station 1. Its neck also comes into operative contact with the feed line 30 which leads to the cavity.

A piston, which protrudes, with a corresponding plunger 16, out of the cartridge is located in each cartridge 9 or 10.1 to 10.3, wherein the counter bearing 17 of said plunger is brought into operative connection with the clamps 18. That is to say that the clamps 18 are opened, such that the counter bearing 17 can engage between the clamps. Thereafter, the clamps 18 are closed, wherein the engage below the counter bearing 17. A connection between the cartridges 9 or 10.1 to 10.3 and the drive 21 is now established.

Next, the substances are filled into the cavity 7. This takes place in what is known as a “one-shot method”, wherein this is known for example from WO 94/02027 or DE 197 32 593 C2, from chocolate production. In this case, firstly pressure is applied, via the corresponding plunger 16, to the piston 15 of the cartridge 9 comprising the substance for the shell. As a result, substance for the shell is filled into the cavity via the feed line 30 and the space between the cladding tube 31 and pressure line 29, such that a base is formed. At the same time or alternatively with a slight delay, the pharmaceutical substances are supplied to the mixing chamber 38 via the feed lines 27.1, 27.2 and 27.3, in which mixing chamber said substances are mixed and are introduced into the cavity via the pressure line 29. A wall for the tablet is raised to the side of the cavity, still during the introducing. The supply of pharmaceutical substance is then interrupted, and the shell is closed by further supply of shell substance.

The detachable connection between the plunger 16 and the clamps 18 serves above all for allowing the plunger 16 to be retracted after the supply of the corresponding substance has ended, with the result that only small amounts of substances are drawn back into the pressure line 29 and the space between the pressure line 29 and cladding tube 31, such that dripping of the substance is thereby prevented.

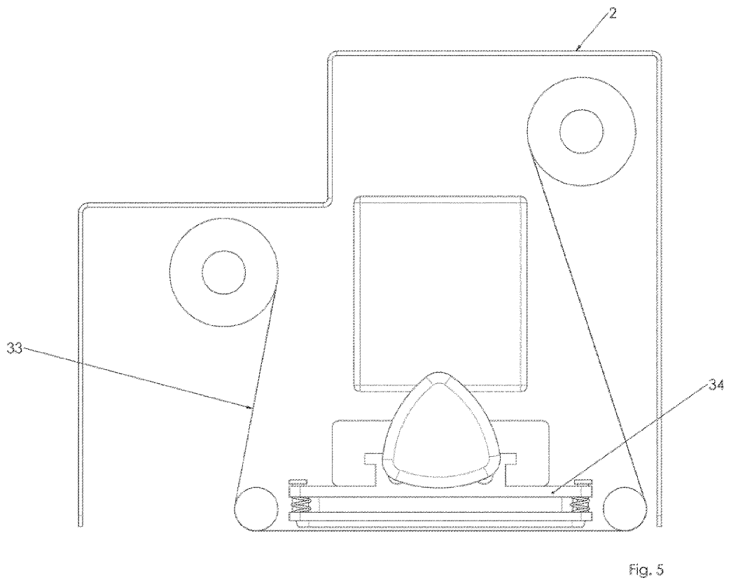

After the cavity 7 or all the cavities of a mold 6 are filled, the mold is transported to the sealing station 2, which is shown in greater detail in FIG. 5. Said sealing station 2 in particular comprises a foil 33, underneath which a sealing tool 34 engages and which is guided over the mold. When the sealing tool 34 is lowered, the foil 33 is sealed onto the mold 6, such that the cavities comprising the produced tablets are now closed.

If wished, said sealing tool 34 can also be designed to be exchangeable, such that different molds can be taken into account. Furthermore, said sealing tool can also be designed simultaneously as a stamping tool, such that the foil is stamped out of a foil strip 33, in the region of the mold.

Thereafter, the mold is supplied to the cooling station 3 via the transport device 5, at which station the entire mold is largely cooled. In the following labelling station 4, all the necessary data are applied to the mold, and data are also read out, which were for example input into the RFID chip in the individual stations.

### LIST OF REFERENCE SIGNS

| | | | | | |
|---|---|---|---|---|---|
| 1 | Filling station | 34 | Sealing tool | | |
| 2 | Sealing station | 35 | | | |
| 3 | Cooling station | 36 | | | |
| 4 | Labelling station | 37 | | | |
| 5 | Transport device | 38 | Mixing chamber | | |
| 6 | Mold | 39 | | | |
| 7 | Cavity | 40 | | | |
| 8 | Protective wall | 41 | | | |
| 9 | Cartridge for shell | 42 | | | |
| 10 | Cartridge | 43 | | | |
| 11 | Cover | 44 | | | |
| 12 | Cladding | 45 | | | |
| 13 | Heat package | 46 | | | |
| 14 | Line | 47 | | | |
| 15 | Piston | 48 | | | |
| 16 | Plunger | 49 | | | |
| 17 | Counter bearing | 50 | | | |
| 18 | Clamp | 51 | | | |
| 19 | Drive train | 52 | | | |
| 20 | Button | 53 | | | |
| 21 | Drive | 54 | | | |
| 22 | Shaft | 55 | | | |
| 23 | Guide sleeve | 56 | | | |
| 24 | Guide column | 57 | | P | Device |
| 25 | Cross-frame | 58 | | | |
| 26 | Distribution block | 59 | | | |
| 27 | Feed line | 60 | | | |
| 38 | | 61 | | | |
| 29 | Pressure line | 62 | | | |
| 30 | Feed line | 63 | | | |
| 31 | Cladding tube | 64 | | | |
| 32 | Neck | 65 | | | |
| 33 | Foil | 66 | | | |

1. Device for producing a pharmaceutical, dietary supplement or cosmetic from at least one active ingredient, wherein the production takes place in a filling station (1) in at least one cavity (7) of a mold (6),
a feed line (30) for a substance for a shell or for a thickening agent, and at least one further feed line (27.1 to 27.3, 29) for the active ingredient are assigned to the cavity (7), or the at least one further feed line (27.1-27.3) is assigned directly to a receiving container.

2. Device according to claim 1, wherein the feed line (30) for the substance for the shell is arranged around the feed line (29) for the active ingredient.

3. Device according to claim 1, wherein the at least one further feed line comprises a plurality of feed lines (27.1-27.3) for the active ingredients.

4. Device according to claim 3, wherein the plurality of feed lines (27.1-27.3) for the active ingredient lead into a mixing chamber (38) upstream of the cavity.

5. Device according to claim 1, wherein the feed line (30) for the substance for the shell, and/or the at least one feed line (27.1-27.3) for the active ingredient is/are connected to a cartridge (9, 10.1-10.3) for the substance for the shell or for the active ingredient.

6. Device according to claim 5, wherein the cartridge (9, 10.1-10.3) is associated with at least one heating device (13.1, 13.2).

7. Device according to claim 6, wherein an air gap is formed between individual cartridges (9, 10.1-10.3).

8. Device according to claim 5, wherein a substance in the cartridge (9, 10.1-10.3) can be acted on by a piston (15).

9. Device according to claim 8, wherein the piston (15) is connected to a drive (21) via a plunger (16).

10. Device according to claim 9, the wherein a connection between the plunger (16) and the drive (21) is releasable.

11. Device according to claim 5, wherein the cartridge (9, 10.1-10.3) has an identifier which is associated with a sensor.

12. Device according to claim 1, wherein a sealing station (2) for the cavity (7) is arranged downstream of the filling station (1).

13. Device according to claim 12, wherein, in the sealing station (2), a foil (33) can be laid over the cavity (7) or the mold (6).

14. Device according to claim 13, wherein the foil (33) over the cavity (7) or the mold (6) is associated with a sealing tool (34) or stamping tool.

15. Device according to claim 14, wherein the sealing tool (34) or stamping tool is exchangeable.

16. Device according to claim 1, wherein a cooling station (3) is arranged downstream of the filling station (1).

17. Device according to claim 1, wherein a labelling station (4) is arranged downstream of the filling station (1).

18. Device according to claim 1, wherein the mold (6) or cavity (7) is transported through the filling station (1) by means of one or more conveyor belts.

19. Device according to claim 18, wherein the conveyor belt connects the filling station (1) to the sealing station (2) and/or cooling station (3) and/or labelling station (4).

20. Method for producing a pharmaceutical, dietary supplement or cosmetic from at least one active ingredient, wherein a feed (30) for a substance for a shell and at least one further feed (27.1-27.3) for the active ingredient to a receptacle takes place simultaneously, at least in part, and wherein a plurality of active ingredients are mixed in a mixing chamber (38) and at the same time the substance for a shell or a thickening agent is supplied to a cavity (7), and wherein, during and after the supply of the active ingredients to the cavity (7), a supply of the substance for the shell takes place, such that the substance for the shell encases the active ingredient.

21. (canceled)

22. (canceled)

23. (canceled)
